(19) United States
(12) Patent Application Publication
(10) Pub. No.: US 2022/0349246 A1
(43) Pub. Date: Nov. 3, 2022

(54) SWITCHABLE OPTICAL DEVICE AND SWITCHABLE GLAZING UNIT

(71) Applicant: MERCK PATENT GMBH, DARMSTADT (DE)

(72) Inventors: Michael JUNGE, Pfungstadt (DE); Michael UKELIS, Riedstadt (DE); Manfred ECKERT, Dieburg (DE); Rainer NEEFF, Neu-Isenburg (DE)

(73) Assignee: MERCK PATENT GMBH, DARMSTADT (DE)

(21) Appl. No.: 17/624,120

(22) PCT Filed: Jun. 29, 2020
(86) PCT No.: PCT/EP2020/068182

§ 371 Date: Dec. 30, 2021

(30) Foreign Application Priority Data
Jul. 2, 2019 (EP) 19183887.9

(51) Int. Cl. E06B 9/24; H05B 3/86

(52) U.S. Cl. CPC E06B 9/24; H05B 3/86; E06B 2009/2464

(57) ABSTRACT

A switchable optical device including in this order a first substrate, a first conductive layer, a switchable layer, a second conductive layer and a second substrate, which device further contains one or both of the following:

i) the first conductive layer contains a first contact zone and a second contact zone, wherein the first contact zone is electrically insulated from the second contact zone and the switchable optical device contains an electrical interconnect for electrically connecting the second contact zone of the first conductive layer the second conductive layer,
ii) the switchable optical device contains at least one further sheet which is laminated to the first substrate and/or the second substrate, wherein first substrate, second substrate and the at least one further sheet have essentially the same thermal expansion coefficient.

A switchable glazing unit containing at least one glass pane and at least one switchable optical device.

The invention relates to a switchable optical device comprising a first substrate, a first conductive layer, a switchable layer, a second conductive layer and a second substrate. Further, the invention relates to a switchable glazing unit comprising at least one glass pane and at least one switchable optical device.

The review article by R. Baetens et al. “Properties, requirements and possibilities of smart windows for dynamic daylight and solar energy control in buildings: A state-of-the-art review”, Solar Energy Materials & Solar Cells 94 (2010) pages 87-105 describes tintable smart windows. Smart windows can make use of several technologies for modulating the transmittance of light such as devices based on electrochromism, liquid crystal devices and electrophoretic or suspended-particle devices. Liquid crystal based devices employ a change in the orientation of liquid crystal molecules between two conductive electrodes by applying an electric field which results in a change of their transmittance.

Liquid crystal based devices usually comprise in this order a first substrate, a switchable layer and a second substrate. The switchable layer comprises at least one liquid crystalline material. The two substrates are coated with a transparent electrode to allow control of the switchable layer by means of an electric field.

In smart windows, the device for modulating the transmittance of light, in the following referred to as switchable optical device, is usually laminated to a further sheet or carrier glass sheet or between two further substrates or carrier glass substrates for protection of the switchable optical device and for mechanical rigidity. In this lamination process, a glass sheet is bonded to a substrate of the switchable optical device by means of a thermoplastic interlayer. In the lamination process, the interlayer is arranged between the carrier glass sheet(s) and the at least one switchable optical device. In a subsequent treatment, which usually involves application of heat and/or elevated pressure or reduced pressure, the at least one sheet, the interlayer and the switchable optical element are bonded.

A smart window may comprise additional panes which form an insulated glazing unit. Further, the smart windows may comprise additional components such as frame for mechanically mounting of the switchable optical device and/or of further panes.

The switchable optical devices are sensitive to dimensional distortions of the substrates. In most switchable devices, such as liquid crystal based devices, the optical properties are strongly dependent on the thickness of the switchable layer. In case of a mechanically distorted substrate, the thickness of the switchable layer is non-uniform resulting in visible changes of the optical properties. Such distortions may occur when laminating the switchable optical device to a sheet having corrugations. This problem is known in the field of display panels and is discussed in U.S. Pat. No. 8,920,592 B2. Smart windows are usually larger than typical LCD displays and may have areas in excess of several square meters. Thus, the problem of dimensional distortions of the devices also applies to smart windows.

Further, the substrates of the switchable optical device are subject to distortions due to mechanical stress. Such mechanical stress may be caused by combining materials having different coefficients of thermal expansion.

GB 2497358 A discloses a method of framing and installing a viewing panel in an aperture of a door. The viewing panel is installed by using a frame which comprises an essentially U-shaped bracket. A portion of the viewing panel is received between two opposing securing members of the bracket. The framed viewing panel is then installed in an aperture of a door. One of the securing members is positioned adjacent to the outer surface of the door so that lateral forces act only in one direction on the fixing means.

WO 02/29471 A1 discloses methods for retrofitting windows with switchable and non-switchable window enhancements. A window enhancement, such as a suspended particle device (SPD) film is mounted on a window using mounting means such as securing strips. The mounting means are placed on a viewing pane of the window. A gap having the same thickness as the mounting means is formed between the window enhancement and the viewing pane. Members may be positioned in the gap in order to maintain the width of the gap.

WO 2016/086062 A1 describes electrochromic windows which may be installed proximate pre-existing windows and corresponding methods and tools. Further, insulated glazing units (IGU) are disclosed wherein one lite includes an electrochromic device. Such an IGU may comprise a vent module to force air through a gap between the electrochromic window and the existing window pane. Further, retainers are disclosed to support a new window which is sealed or glued to a pre-existing window in case the seal or adhesive fails.

The known methods for mounting glass elements or switchable window elements provide securing members or securing strips which contact the element to be mounted at the respective edges. Further elements are required to provide for the necessary electrical connections.

It is an object of the present invention to provide a switchable optical device which may be easily integrated in a smart window. It is a further object of the invention to provide a switchable glazing unit having uniform optical properties.

A switchable optical device comprising in this order a first substrate, a first conductive layer, a switchable layer, a second conductive layer and a second substrate is provided. The switchable optical device further comprises one or both of the following aspects:

In a first aspect i) the first conductive layer comprises a first contact zone and a second contact zone, wherein the first contact zone is electrically insulated from the second contact zone and wherein the switchable optical device comprises an electrical interconnect for electrically connecting the second contact zone of the first conductive layer to the second conductive layer.

In a second aspect ii) the switchable optical device comprises at least one further sheet which is laminated to the first substrate and/or the second substrate, wherein first substrate, the second substrate and the at least one further sheet, have essentially the same thermal expansion coefficient.

The first substrate, the second conductive layer, the switchable layer, the second conductive layer and a second substrate form a switchable element. The switchable optical device may comprise a single switchable element or may comprise more than one switchable element. For example, the switchable element may comprise two or three switchable elements.

The switchable element has at least two switching states. The switching states may, for example, include a clear and transparent state, a dark state, a hazy state and mixtures of at least two of these states. Areas of the switchable element in which elements such as glue lines, electric connections and electric driving circuits are located are not affected by switching of the switching layer and are referred to as non-switchable areas.

Preferably, the transmission through the switchable optical device for at least one of the states, preferably in a transparent state, is at least 40% for light in the visible spectrum. More preferably the transmission is at least 50%. The visible spectrum is defined as light having a wavelength of from 380 nm to 780 nm.

Preferably, the switchable optical device comprises at least two switchable elements. Preferably, switchable elements of different types are combined. The switchable elements may be stacked on top of each other and joined, for example, by lamination or by means of an optically clear adhesive. The switchable optical device may, for example, include a first switchable element having a hazy state and a clear state, and a second switchable element having a dark state and a clear bright state.

The optical state of the switchable layer of the switchable element is controlled by means of the two conductive layers. For providing control signals to the two conductive layers, the switchable optical device may be connected to a controller. The first and second conductive layers have contact zones which are located outside of a switchable area of the switchable optical device. The area of the conductive layers located within the switchable area serves as electrode zone. The switchable area of the switchable optical device is the area, in which the optical properties may be controlled by switching the state of the switchable layer.

Preferably, the switchable element is a liquid crystal based element. In this case, the switching layer comprises a liquid crystalline medium. The state of the liquid crystalline medium is controlled by an electric field which is applied by means of the two electrodes. The liquid crystalline medium may comprise further components such as spacers in order to ensure a uniform thickness of the liquid crystal based switchable layer.

Preferably, the switchable element is a liquid crystal (LC) device selected from modes based on either LC-dye mixtures/LC without dyes and modes described by geometry of twisted nematic, super twisted nematic, planar or vertical ECB nematic, Heilmeier, vertically aligned, twisted vertical aligned, highly twisted nematic, polymer stabilized cholesteric texture (PSCT), polymer networked liquid crystal (PNLC) or polymer dispersed liquid crystal (PDLC). The device may include further functional layers such as, for example, color filters, alignment layers and/or polarizers. Optionally, two or more of such switchable elements may be stacked in the switchable optical device.

Preferably, the liquid crystal based element additionally comprises an alignment film located on the first substrate layer and/or the second substrate layer. The alignment film is preferably arranged on the side facing the switchable layer. If an electrode is also located on the respective substrate layer, the alignment film is preferably arranged on the conductive layer so that the alignment film is in direct contact with the switchable layer. The alignment film may be rubbed in an alignment direction.

The two substrate layers and the liquid-crystalline medium are arranged as a cell wherein the liquid-crystalline medium is placed in the gap formed by the two control layers. The size of the gap is preferably from 1 μm to 300 μm, preferably from 3 μm to 100 μm and more preferably from 5 μm to 100 μm, and most preferably from 10 μm to 50 μm. The cell is usually sealed by means of glue lines located at or near the edges.

The switchable layer of a liquid crystal based switchable element comprises a liquid-crystalline medium. A liquid-crystalline medium is defined as a substance having the properties of a liquid crystal. Typical liquid-crystalline media comprise at least one composition having elongated rod-shaped molecules. The liquid-crystalline media used in conjunction with the present invention have at least two states. The state of the liquid-crystalline medium is controlled using an electric field which is generated by an AC driving voltage applied between the two electrodes.

Preferably, the switchable element is a suspended particle device. In this case, the switchable layer preferably comprises particles suspended in a liquid. Usually, the particles have a rod-like shape. Without an applied electric field, the suspended particles are randomly organized. In this state, the particles block and absorb light. When an electric field is applied, the suspended particles align and light may pass through the switching layer.

Preferably, the switchable element is an electrochromic device. In electrochromic devices, a switchable layer is used which is able to change its optical properties reversibly if an electric field is applied. This change of optical properties is associated with ion insertion and extraction processes. The switchable layer is sandwiched between the two substrates coated with the conductive layers and usually comprises in this order one or more cathodic electroactive layer(s), an ion conductor and an ion-storage film or one or more complementary anodic electroactive layers.

The first and/or second substrate is preferably optically isotropic and transparent. The first and second substrates are preferably independently selected from a glass or a transparent polymer. Examples for a suitable glass include, for example, alkaline earth boro-aluminosilicate glass, chemically toughened glass, aluminosilicate glass, borosilicate glass and soda lime glass. Examples for suitable transparent polymers include polycarbonate (PC), cyclo-olefin polymer (COP), polyethylene terephthalate (PET), polyimide and polyethylene naphthalate (PEN).

Preferably, same material is used for both substrates.

The substrates may have any size and shape. For example, the substrates may have a square or rectangular shape. Preferably, the first and second substrates have the same size and shape. Alternatively, the second substrate may be of smaller size or may have a different shape. For example, the second substrate may comprise cut-outs or cut corners to allow access to the first conductive layer of the switchable optical device.

In order to apply an electric field to the switchable layer, the first and second conductive layers are provided. An electric field is generated between the two electrodes by applying a voltage to the electrodes, for example by means of a driving signal. Preferably, the electrodes are transparent conductive layers, wherein the switchable layer is arranged between two transparent conductive layers. A power supply apparatus which may include a driving signal generator and cables may be used to supply the voltage to the electrodes.

The first and/or second transparent conductive layers are, for example, based on a thin layer of indium tin oxide (ITO), fluorine tin oxide (FTO), aluminum zinc oxide (AZO), indium gallium zinc oxide (IGZO) or antimony tin oxide (ATO). Further, the conductive layers may be configured as polymer matrix comprising conductive nanorods such as silver nanorods. The electrodes are preferably applied to the two substrates and are arranged such that the transparent electrodes face each other. A SiOx coating may optionally be used underneath or as topcoat.

The switchable optical device of the second aspect ii) comprises at least one further sheet which is laminated to the first substrate and/or the second substrate. A further sheet may also be used in conjunction with the switchable optical device of the first aspect i).

The further sheet is preferably optically transparent and may be selected from a polymer or a glass.

Suitable materials for the further sheet include the same materials that may be used for the first and/or second substrate. Further, it is possible to use other materials such as, for example, float glass or downdraw glass. The glass may also have been subjected to a pre-processing step like tempering, toughening and/or coating or sputtering. The glass can be, for example, soda-lime glass, borosilicate glass, boro-aluminosilicate glass or aluminosilicate glass.

Preferably, the at least one further sheet is made from the same material as the two substrates.

Preferably, the thickness of the at least one further sheet is in the range of from 2 mm to 10 mm, wherein a range of from 2 to 6 mm is more preferred.

The thickness of the at least one further sheet is preferable of the same order of magnitude as the thickness of the switchable element formed by the two substrates and all the layers between the two substrates. Accordingly, the thickness of the switchable element is the sum of the thicknesses of the layers between, the first and second substrate and the thickness of the two substrates. The thickness of the at least one further sheet is preferably less than 110% of the thickness of the switchable element.

For lamination, a lamination sheet (interlayer) is arranged between the at least one further sheet and the first and/or second substrate of the switchable element. In a subsequent treatment, which usually involves application of heat and/or elevated pressure or reduced pressure, the at least one sheet, the interlayer and the switchable element are bonded.

Suitable lamination sheets include, for example, an ionoplast, ethylene vinyl acetate (EVA), polyvinyl butyral (PVB) or thermoplastic polyurethane (TPU).

A suitable ionoplast is available under the trade name SentryGlas.

Alternatively, the at least one further sheet and the at least one switchable element may be bonded by applying an adhesive at the interface between the further sheet and the first substrate layer. In particular, an optically clear adhesive (OCA) may be used.

Preferably, the used first substrate, second substrate and/or the at least one further sheet are essentially flat and microcorrugations are less than 0.3 μm per 20 mm measurement length (measured using cut-off wavelength 0.8 to 8 μm). The microcorrugations or flatness of the respective substrate or sheet may, for example, be measured by means of touch probes, or optical measurement methods based on interference or ellipsometry.

Examples for suitable flat glass substrates are, for example alkaline earth boro-aluminosilicate glass available from Corning under the trade name Corning® Eagle XG® Glass. Further suitable examples include Corning® Gorilla™ Glass and polished borofloat glass available from Asahi.

Aspect i) of the switchable optical device allows supplying the electrical control signal for the second conductive electrode by applying the electrical control signal to the second contact zone of the first conductive layer. Thus, both conductive layers may be contacted by the respective contact zones of the first conductive layers. The control signal for the second conductive layer is supplied by means of the electrical interconnect.

Preferably, the electrical interconnect is selected from conductive adhesives, structured conductive films, metal spacers and combinations thereof.

The electrical interconnect has a thickness sufficient to bridge the gap between the first conductive layer and the second conductive layer. The electrical interconnect is arranged in the second contact zone. In case a conductive adhesive is used, the adhesive is preferably provided in form of a glue line arranged in the second contact zone. Directly after the application, the thickness of the glue line is preferably larger than the thickness of the gap. After the layer structure of the switchable element has been assembled, the glue line is squashed and has a final thickness identical to the gap thickness. The electrically conductive adhesive may be an isotropic or anisotropic conductive adhesive.

In case metal spacers are used, the metal is preferably selected from gold, copper, nickel and alloys of the described metals. Further suitable spacer materials include graphite and other carbon modifications. The spacers preferably have a spherical shape having the same diameter as the size of the gap or are slightly larger than the size of the gap. The spacers may be combined with a conductive or a non-conductive adhesive.

In case a structured conductive film is used, the conductive film comprises vertically extending structures such as corrugations, wherein the height of the structures is sufficient to bridge the gap between the first and second conductive layers.

The first contact zone of the first substrate preferably extends along at least two edges of the first substrate. The first contact zone may have a “L”-shape, wherein one leg extends over a first part of a first edge of the substrate and over the entire length of an adjacent second edge of the first substrate. The first and second contact zones are separated by an insulated zone. The second contact zone preferably extends along the entire length of at least one edge of the first substrate. Preferably, the second contact zone extends over the entire length of a third edge of the first substrate which is adjacent to the first edge.

Preferably, the first and second contact zones are arranged such that the first contact zone and the second contact zone abut against the same edge of the first substrate. Preferably, the first contact zone and the second contact zone both abut against the first edge of the first substrate and are separated by the insulated zone.

Preferably, a metallic conductor extends over the entire area of the first contact zone and/or a metallic conductor extends over the entire area of the second contact zone. Preferably, the metallic conductor is configured as a multi-layer film structure comprising in this order gold, chrome and copper. The multi-layer film structure may be obtained in a sputter process. Alternatively, other film forming techniques such as galvanic deposition, physical vapor deposition (PVD) or chemical vapor deposition (CVP) may be used. Additionally or alternatively, a metal conductor such as a metal strip may be bonded to the first conductive layer in order to form the metallic conductor.

In order to allow for electrically contacting of the first conductive layer, it is preferred to configure and/or arrange the second substrate such that at least a part of the first contact zone and of the second contact zone are not covered by the second substrate.

Preferably, the second substrate is smaller than the first substrate and is arranged centered above the first substrate or is aligned to the first edge of the first substrate in one dimension and centered in the other dimension. Alternatively, the second substrate comprises at least one cut corner and/or multiple cut-outs arranged on at least one edge of the second substrate.

In case of cut corners, it is preferred to arrange to cut corners such that they are arranged along a first edge of the second substrate and to arrange the second substrate such that the first edge of the second substrate is aligned to the first edge of the first substrate.

The multiple cut-outs are preferably configured as a sinusoidal shaped edge or multiple cut-outs shaped as half circles, rectangles or rounded rectangles, respectively. The multiple cut-outs are arranged such that when the second substrate is placed above the first substrate, at least one cut-out is over the first contact zone and at least one cut-out is over the second contact zone.

Preferably, the corner cut and/or the multiple cut-outs are produced by laser cutting. Laser cutting produces smooth edges which differ from other cutting methods. The risk of breakage is reduced by the surface finish obtained by laser cutting

Preferably, the switchable optical device further comprises a first metal contact sheet which contacts the first contact zone and a second metal contact sheet which contacts the second contact zone, wherein the first and second metal contact sheets extend beyond the first substrate and are bent such that they cover parts of an edge-surface of the first substrate and, if present, of an edge-surface of the further sheet laminated to the first substrate.

Preferably, the first and/or second metal contact sheets partially cover an edge surface of the first edge of the first substrate.

Preferably, a first cable is connected to the first contact zone and a second cable is connected to the second contact zone and/or the first electrical contact zone and the second electrical contact zone have metallized surfaces configured for a spring contact.

Cables may, for example, be connected to the respective contact zone of the first conductive layer be means of welding or soldering, in particular by means of ultrasonic soldering. The cables may be connected directly to the first conductive layer or may be connected to a metallic conductor of the respective contact zone. Preferably, the cables connections are arranged on the same edge of the first substrate, in particular the first edge of the first substrate.

The cable connections in the respective contact zone are preferably protected by means of a cover. For example, the connections are covered by means of a potting material.

The metallized surface may, for example, be a multi-layer film structure. The metallized surface may be a part of a metallic conductor arranged in the first and/or second contact zone.

In the second aspect ii) the switchable optical device comprises at least one further sheet which is laminated to the first substrate and/or the second substrate. The first substrate, the second substrate and the at least one further sheet, have essentially the same thermal expansion coefficient.

The term “essentially the same coefficient of thermal expansion” means that only minor differences in the coefficient of thermal expansion exist between all substrates and glass sheets used in the switchable optical device. Preferably, the difference between the largest and the smallest coefficient of thermal expansion is less than 5% and more preferably less than 1%. Most preferably identical materials are used for the first substrate, the second substrate and the at least one further sheet so that all further sheets and substrates of the switchable optical device have the same coefficient of thermal expansion.

The switchable optical device of aspects i) and/or ii) may comprise additional features such as additional functional films and coatings.

Preferably, at least one of the first substrate, the second substrate and/or the at least one further sheet comprises a transparent electrical heater film. The heater film may be a transparent electrically conductive film. In particular, the heater film may be an ITO or FTO film.

For contacting of the heater film, electrical contacts similar to those described with respect of the first conductive layer may be used.

Further, a method for producing a switchable optical device is proposed.

In a first step a) a first substrate which is coated with the first conductive layer is provided. The first conductive layer may, for example, be a transparent ITO layer. The first conductive layer is structured, for example by means of a laser process, to form the insulated zone. The first substrate may be laminated to a further sheet by means of an interlayer.

In a second step b), first alignment layer for liquid crystals is applied. The first alignment layer is, for example, a polyimide layer. The first alignment layer is structured, for example by rubbing.

In a third step c), a glue line for forming a seal for liquid crystalline medium is applied. Also, an electrical interconnect is prepared by applying an adhesive comprising metal spacers. Optionally, the first alignment layer is partially removed before applying the glue line and/or before preparing the electrical interconnect.

In a forth step d), the liquid crystalline medium is provided, for example by means of one drop filling or inkjet printing. The liquid crystalline medium may comprise spacers to ensure a uniform thickness of the switchable layer.

A fifth step e) is performed in vacuum. Air is evacuated, for example in a vacuum assembly-unit and a second substrate is provided. The second substrate is placed onto the prepared glue line by means so that the second substrate is aligned to the first substrate. The second substrate is coated with a second conductive layer and also preferably comprises a second alignment layer.

In a last step f) the adhesives used in the glue line and the electrical interconnect are cured, for example by means of UV-radiation, by means of heat or by a combination of heat and UV-radiation.

Alternatively to steps d), e) and f) other methods for filling the cell with the liquid crystalline medium may be used. For example, the cell may be formed first by placing the second substrate onto the glue line and the cell may then be filled by means of a vacuum filling process.

In a further aspect of the invention, a switchable glazing unit comprising at least one glass pane and at least one switchable optical device is provided. The at least one switchable optical device is mechanically decoupled from the at least one glass pane of the glazing unit. Further, the switchable glazing unit comprises at least one of the following aspects:

In a first aspect a) the switchable glazing unit comprises means for electrically contacting the at least one switchable optical device which include at least one electrical spring contact.

In a second aspect b) the switchable glazing unit is constructed as an insulated glazing unit comprising two or more panes with gaps between the panes and the at least one switchable optical device is used as one of the panes of the insulated glazing unit.

In a third aspect c) the switchable glazing unit has at least one switchable optical device as described herein.

For mechanically decoupling of the switchable optical device from the at least one glass pane of the glazing unit, a bonding over the entire area of the switchable optical element is avoided. Instead, it is preferred to hold or attach the switchable optical element at or near the edges. Also, the switchable glazing unit is preferably constructed and arranged such that the at least one switchable optical device may freely expand or contract when temperature changes.

For holding the switchable optical device at its respective edges, the switchable glazing unit may comprise one or more holding elements and/or mounting elements. The holding element may, for example, have essentially a “U”-shaped profile for engaging the switchable optical element. The mounting element may, for example, be a spacer which is arranged between the switchable optical element or a window element and a pane of an existing window. The mounting element may be attached to the pane of an existing window, for example, by means of an adhesive.

The mounting element may alternatively be constructed as a rail which is attached to a pane of an existing window, such as an insulated glazing unit (IGU). A switchable optical element may then be installed by inserting the element into the rail.

Due to the mechanically decoupling, a dimensional change of a glass pane of the window is not directly transferred to the switchable optical device. This is especially important if the coefficient of thermal expansion of the at least one glass pane of the switchable glazing differs from the coefficient of expansion of the substrates and, if present, of the at least one further sheet of the switchable optical device.

For example, the coefficient of thermal expansion for soda-lime glass is α=9.2·10⁻⁶ 1/K and the coefficient of thermal expansion for boro-silicate glass is α=3.2·10⁻⁶ 1/K. Soda-lime glass is commonly used for window panes and boro-silicate glass is a typical glass used as substrate for liquid crystal based switchable optical devices. The thermal expansion may be approximated using the equation

ΔL˜αL₀Δt

wherein ΔL is the change in length, L₀ is the initial length and Δt is the change in temperature. For a temperature difference of e.g. 120° C. (for example the difference in temperature between 20° C. room temperature and a typical lamination temperature of 140° C. and room temperature), a soda-lime glass of a 3.5 meter length glass expands by ˜3.9 mm and the boro-silicate glass by ˜1.3 mm. If a switchable optical device comprising boro-silicate glass substrates would be bonded to a further sheet of soda-lime glass by lamination over the full surface area, such a difference in thermal expansion causes mechanical stress.

Preferably, the switchable glazing unit further comprises at least one window element comprising the at least one switchable optical device, a frame for mechanical decoupling and electrical contacting of the at least one switchable optical device and at least one electrical spring contact for contacting the at least one switchable optical device.

The frame preferably comprises at least one air channel. The air channel allows for ventilation of an air gap between the switchable optical device and the at least one glass pane of the switchable glazing unit.

Preferably, the frame is made from three types of frame profile parts, wherein the sides of the frame are formed respectively by a first profile part having a U-shaped profile and the top and bottom sides of the frame are formed respectively by a second profile part having a L-shaped profile and a third profile part having a rectangular profile. The second and third profile parts are combined to form a “U”-shape for receiving the switchable optical device.

Preferably, the material of the profile parts is selected from an electrically non-conducting material. Suitable examples of electrically non-conducting materials include wood, plastic materials and fiber reinforced plastic materials. The use of fiber reinforced plastic material is preferred; in particular glass fiber reinforced plastic materials. A suitable example for the plastic material is polyamide which, for example, is reinforced with 50% glass fibers.

Preferably, the switchable glazing unit further comprises electrical spring contacts for electrically contacting the at least one switchable window element. Additionally or alternatively, the switchable window element, preferably further comprises an electrical cable, an electrical socket or an electrical contact surface for electrically contacting of the switchable window element.

Preferably, the electrical spring contact for contacting the at least one switchable optical device according to aspect a) and/or for contacting the at least one switchable window element is configured as a bending spring or a spring loaded contact pin. Further, in order to improve corrosion resistance it is preferred to use plated noble metal contacts for the bending spring or the spring loaded contact pin. Preferably, gold is used as noble metal.

Preferably, the switchable glazing unit further comprises an insulated glazing unit having two or more panes with gaps between the panes and the at least one switchable optical device is arranged adjacent to one of the panes.

The insulated glazing unit comprises spacer elements between the panes.

In case the switchable optical device is arranged adjacent to one of the panes of an insulated glazing unit, the switchable glazing unit preferably comprises means for venting of a space between switchable optical device and the insulated glazing unit.

In case the switchable optical device is used as one of the panes of an insulated glazing unit according to aspect b) of the invention, the at least one switchable optical device may be used as a first pane, which, when the window is installed faces outwards, as a second pane, which when the window is installed faces inwards, or as a middle pane in case the insulated glazing unit comprises more than two panes.

Such an embodiment has the advantage that the total thickness of the switchable glazing unit can be reduced. For example, a thickness of the switchable glazing unit may be reduced to about 23 mm for use in vehicles, e.g. for train applications, marine or aviation or to less than 40 mm for architectural applications. The concept of introducing thin light-weighed switchable optical devices into the middle of a triple glazing insulated glazing unit means a weight reduction of about 40% while achieving at the same time better thermal stability and better g- and u-values.

In cases where the switchable optical device is used as or respectively in a second pane facing inwards or especially a middle pane and where the switchable optical device may have a tendency to absorb significant amounts of light and in particular heat, it can be preferable to provide a means to compensate for or respectively to dissipate unwanted or excessive heat input. Such means may include for example the use of heat-conducting films, heat-conducting gases, or in particular using different gases for different gap spaces, Peltier elements which optionally may be coupled with solar cells or thermoelements, solar fans, heat-controlling coatings etc.

In cases where the switchable optical device is used as or respectively in a first pane facing outwards, it is preferred that the switchable optical device is laminated to a strengthened or toughened glass, preferably thermally or chemically toughened glass, aluminosilicate glass or borosilicate glass and in particular aluminosilicate glass or borosilicate glass.

Preferably, at least one glass pane and/or at least one switchable optical device of the switchable glazing unit comprises a low-e coating. Preferably, the low-e coating is arranged on a surface of a switchable optical device or a glass pane which faces towards a gap of the insulated glazing unit.

In an embodiment it is also possible to provide, in addition or alternatively to a low-e coating, an anti-reflective coating on at least one surface of a glazing, a switchable optical device or a glass pane. In this case preferably a multilayer optical thin film coating of metal oxides is applied to give interference optical coated glass. The metal oxides can provide non-corroding, hard and durable coatings which are thus suited even for top layers or exterior surfaces. The anti-reflective coating may be applied to one or both sides of a glass pane and/or to one or more glass panes of an insulated glazing unit. It is particularly preferred that the anti-reflective coating is provided on the outside or exterior surface of the outermost pane, in particular the side facing the light source, of the glazing unit.

In the case that a switchable area of the at least one switchable optical device is smaller than an optically clear area of the at least one glass pane of the switchable glazing unit it is preferred that the switchable glazing unit additionally comprises a passepartout-frame for covering spacer-blocks and/or non-switching areas of the at least one switchable optical device.

Advantageously, the border of the passepartout-frame also obscures parts of the switchable optical device which are sensitive to degradation by light and or areas that are aesthetically not attractive. Such areas include parts of the switchable optical element that are not switching such as sealants, glue lines and/or electrical connectors. Usually, non-switching areas of the switchable optical element such as the sealing (glue lines), electric connections and/or electric driving circuits are located at or near the edges of the switchable optical device.

Preferably, the switchable glazing unit additionally comprising a UV-absorbing layer arranged prior to the at least one switchable optical device when viewed from the outward facing side of the switchable glazing unit.

The UV-absorbing layer may be a doped interlayer, in particular a doped PVB interlayer, a UV-paint, an adhesive film containing UV-protection or a printed or coated film of UV-absorbing material.

The at least one switchable optical device of the switchable glazing unit is preferably selected from liquid crystal based devices, electrochromic devices, gasochromic devices, thermochromic devices, thermally switchable devices, electrophoretic devices, suspended particle devices or combinations of at least two of these switchable optical devices.

Preferably, at least one glass pane and/or at least one switchable optical device of the switchable glazing unit comprises a transparent electrical heater film.

Preferably, the switchable glazing further comprises a controller for electrically controlling switching of the at least one switchable optical device. The controller is adapted for supplying electricals signals necessary for switching the at least one switchable optical device from one state to another state and/or for holding the at least one switchable optical device in a certain state. The electrical signal may be selected from direct-current signals and alternating current signals such as square wave, sine wave or arbitrary wave-form signals.

The switchable glazing unit may comprise additional elements such as a window frame.

The switchable glazing unit may be provided as a new device for first installation or replacement of existing windows of a building or a vehicle. Alternatively, the switchable glazing unit may be based on an existing window of a building or a vehicle which is retrofitted by combining the existing window with at least one switchable optical device.

It is a further aspect of the invention to provide a process for producing such a switchable glazing unit. The process comprising the steps of

a) providing a window comprising a window frame and at least one glass pane,

b) optionally attaching mounting elements to the at least one glass pane, and

c) attaching a switchable optical device by means of holding elements or a frame to the glass pane.

Alternatively, the process comprises the steps of

a) providing a window comprising a window frame and an insulated glazing unit,

b) disassembling the insulated glazing unit,

c) reassembling the insulated glazing unit, wherein a switchable optical device is used as one of the panes of the insulated glazing unit.

Preferably, the switchable optical device is one of the switchable optical devices described herein.

In a further aspect of the invention, a switchable window is provided which comprises a window frame and at least one of the described switchable optical devices and/or at least one of the described switchable glazing units.

Preferably, the switchable window is used as a window of a vehicle or building. The vehicle may, for example, be a land-based vehicle such as car, truck, bus or train, a ship, an airplane, or a spacecraft.

### EXAMPLES

### Example 1

An insulated glazing unit (IGU) comprising a switchable optical device having two switchable elements is provided. The IGU comprises three panes, wherein the switchable optical device is used as middle pane. The first glass pane facing outside and the second glass pane facing towards the inside are made from a first type of glass and the substrates of the switchable optical devices are made from a second type of glass. The layer structure is given in table 1.

TABLE 1

| Layer | Outside/Air Atmosphere |
|---|---|
| First glass pane | Laminated 2 to 12 mm glass, e.g. 2 × 4 mm tem- |
| | pered or toughened glass laminated with PVB in- |
| | cluding UV cut at 400 nm (Trosifol UV Protect or |
| | Eastman RU41 |
| Air gap | Gas Cavity of 4 to 16 mm, e.g. air, Ar, etc. de- |
| | pending on application |
| First substrate | 0.5 to 0.7 mm thin Eagle XG or equivalent glass |
| 1st conductive | 25 nm ITO |
| layer | |
| Alignment layer | planar or vertical PI alignment layer with defined |
| | small pre-tilt angle |
| Switchable layer | LC mixture with 2 to 25 μm cell gap |
| Alignment layer | planar or vertical PI alignment layer with defined |
| | small pre-tilt angle |
| 2nd conductive layer | 25 nm ITO |
| 2nd substrate | 0.5 to 0.7 mm thin Eagle XG or equivalent glass |
| Interlayer | 0.76 mm lamination foil, e.g. PVB |
| 1^{st} substrate | 0.5 to 0.7 mm thin Eagle XG or equivalent glass |
| 1^{st} conductive layer | 25 nm ITO |
| Alignment layer | planar or vertical PI alignment layer with defined |
| | small pre-tilt angle |
| Switchable layer | LC mixture with 2 to 25 μm cell gap |
| Alignment layer | planar or vertical PI alignment layer with defined |
| | small pre-tilt angle |
| 2^{nd} conductive layer | 25 nm ITO |
| 2^{nd} substrate | 0.5 to 0.7 mm thin Eagle XG or equivalent glass |
| Air gap | Gas Cavity of 4 to 16 mm, e.g. air, Ar, etc. de- |
| | pending on application |
| Second glass pane | 2 to 12 mm soda-lime glass; toughened or tem- |
| | pered glass |
| coating | LowE coating |
| | Inside/Air Atmosphere |

### Example 2

An insulated glazing unit (IGU) comprising a switchable optical device having only one switchable element is provided. The switchable optical device comprises two further sheets for enhancing the mechanical strength of the device. The IGU comprises three panes, wherein the switchable optical device is used as middle pane. The first glass pane facing outside and the second glass pane facing towards the inside are made from a first type of glass and the substrates of the switchable optical device as well as the further sheets are made from a second type of glass. The layer structure is given in table 2.

TABLE 2

| Layer | Outside/Air Atmosphere |
|---|---|
| First glass pane | Laminated 2 to 12 mm glass, e.g. 2 × 4 mm tem- |
| | pered or toughened glass laminated with PVB in- |
| | cluding UV cut at 400 nm (Trosifol UV Protect or |
| | Eastman RU41 |
| Air gap | Gas Cavity of 4 to 16 mm, e.g. air, Ar, etc. de- |
| | pending on application |
| Further sheet | 0.5 to 0.7 mm thin Eagle XG or equivalent glass |
| Interlayer | 0.76 mm lamination foil, e.g. PVB |
| First substrate | 0.5 to 0.7 mm thin Eagle XG or equivalent glass |
| 1st conductive | 25 nm ITO |
| layer | |
| Alignment layer | planar or vertical PI alignment layer with defined |
| | small pre-tilt angle |
| Switchable layer | LC mixture with 2 to 25 μm cell gap |
| Alignment layer | planar or vertical PI alignment layer with defined |
| | small pre-tilt angle |
| 2nd conductive layer | 25 nm ITO |
| 2nd substrate | 0.5 to 0.7 mm thin Eagle XG or equivalent glass |
| Interlayer | 0.76 mm lamination foil, e.g. PVB |
| Further sheet | 0.5 to 0.7 mm thin Eagle XG or equivalent glass |
| Air gap | Gas Cavity of 4 to 16 mm, e.g. air, Ar, etc. de- |
| | pending on application |
| Second glass pane | 2 to 12 mm soda-lime glass; toughened or tem- |
| | pered glass |
| coating | LowE coating |
| | Inside/Air Atmosphere |

### BRIEF DESCRIPTION OF THE DRAWINGS

The drawings show:

FIG. 1 a schematic side view of a switchable optical device,

FIG. 2 a top view of the switchable optical device,

FIGS. 3a to 3f a process for manufacturing of the switchable optical device,

FIG. 4 the switchable optical device in perspective view,

FIGS. 5a to 5f alternative embodiments of the switchable optical device,

FIG. 6 a switchable optical device having multiple cut-outs in perspective view,

FIGS. 7a and 7b alternative shapes for the cut-outs,

FIG. 8 an embodiment of the switchable optical device including film heaters,

FIG. 9 a window element in top view,

FIG. 10 a cross section of the contact area of the window element,

FIG. 11 the window element in perspective view,

FIG. 12 a first embodiment of a switchable glazing unit,

FIG. 13 a second embodiment of the switchable glazing unit,

FIGS. 14a and 14b alternative embodiments of electrical contacts,

FIGS. 15a and b a third embodiment of the switchable glazing unit,

FIG. 15c alternative electrical contacts,

FIG. 16 a forth embodiment of the switchable glazing unit,

FIG. 17 a fifth embodiment of the switchable glazing unit,

FIG. 18a a sixth embodiment of the switchable glazing unit,

FIG. 18b the sixth embodiment with different size of the switchable optical device, and

FIGS. 19a and 19b two embodiments of holders having spring contacts.

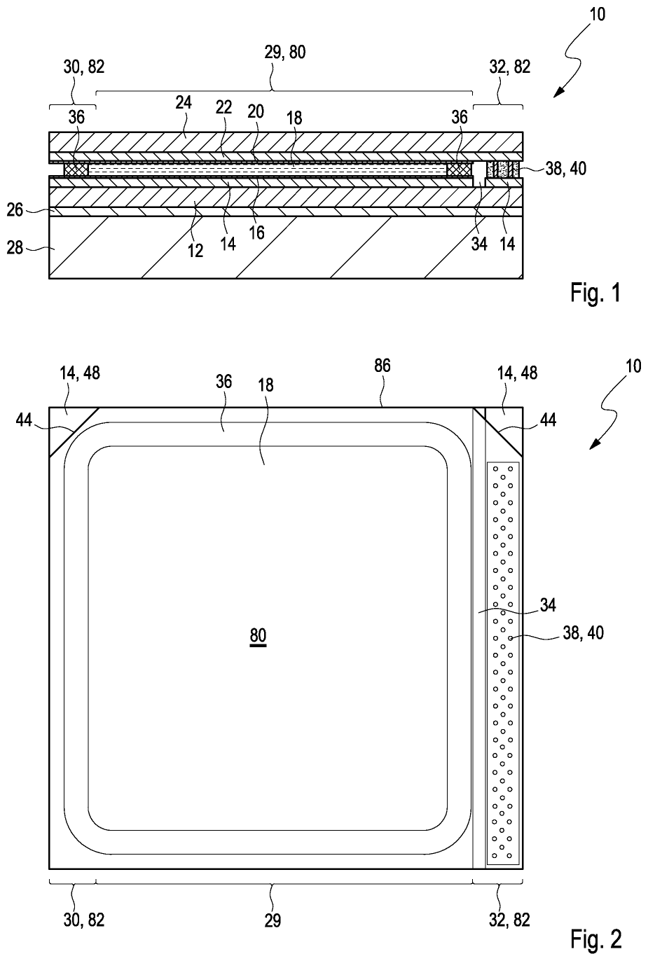

FIG. 1 shows a schematic side view of a switchable optical device 10. The switchable optical device 10 has a layer structure which comprises in this order a first substrate 12, a first conductive layer 14, a first alignment layer 16, a switchable layer 18, a second alignment layer 20, a second conductive layer 22 and a second substrate 24. Said layer structure forms a switchable element which has at least two states. The state of the switchable layer 18 is controlled by applying an electric driving signal to the first conductive layer 14 and the second conductive layer 22.

In the embodiment shown in FIG. 1, the switchable optical device 10 is constructed as a liquid crystal based device. The switchable layer 18 therefore comprises a liquid crystalline medium and is sealed by means of a glue line 36. The liquid crystalline medium which is located in the area of the switchable optical device within the glue line 36 may switch its state when an appropriate driving signal is applied to the first conductive layer 14 and second conductive layer 22. The area within the glue line 36 is also called switchable area 80 and the remaining area is also called non-switchable area 82.

The first conductive layer 14 is divided into a first area and a second area by means of an insulated zone 34. The first area comprises a first contact zone 30 and an electrode zone 29. The second area comprises a second contact zone 32. The first contact zone 30 and the second contact zone 32 as well as the insulted zone 34 are located in the non-switchable area 82 and the electrode zone 29 is located in the switchable area 80.

For supplying the electric driving signal to the second conductive layer 22, the second contact zone 32 of the first conductive layer 14 is used. The driving signal is transferred from the second contact zone 32 to the second conductive layer 22 by means of an electrical interconnect 38. In the embodiment of FIG. 1, the electrical interconnect 38 is formed by metal spacers 40 which are embedded in an adhesive material.

The switchable optical device 10 of FIG. 1 additionally comprises a further sheet 28 for providing additional mechanical stability. The further sheet 28 is laminated to the other surface of the first substrate 12 by means of an interlayer 26. Additionally or alternatively to the further sheet 28 the switchable optical device 10 may comprise a second layer structure forming a second switchable element. The second switchable element may, for example, be laminated to the first substrate 12 by means of the interlayer 26.

FIG. 2 shows a top view of a switchable optical device 10. The glue line 36 and the electrical interconnect 38 are visible as the second substrate 24, see FIG. 1, is transparent. As can be seen form FIG. 2, the first conductive layer 14, see FIG. 1, is divided by the insulated zone 34 in a first area comprising the first contact zone 30 and the electrode zone 29 and a second area comprising the second contact zone 32. In the shown embodiment of FIG. 2, the first contact zone 30 surrounds the electrode zone 29 and, in particular extends along a part of a first edge 86 and along an entire second edge adjacent to the first edge 86. The second contact zone 32 extends along a part of the first edge 86 and along the entire length of a third edge adjacent to the first edge 86.

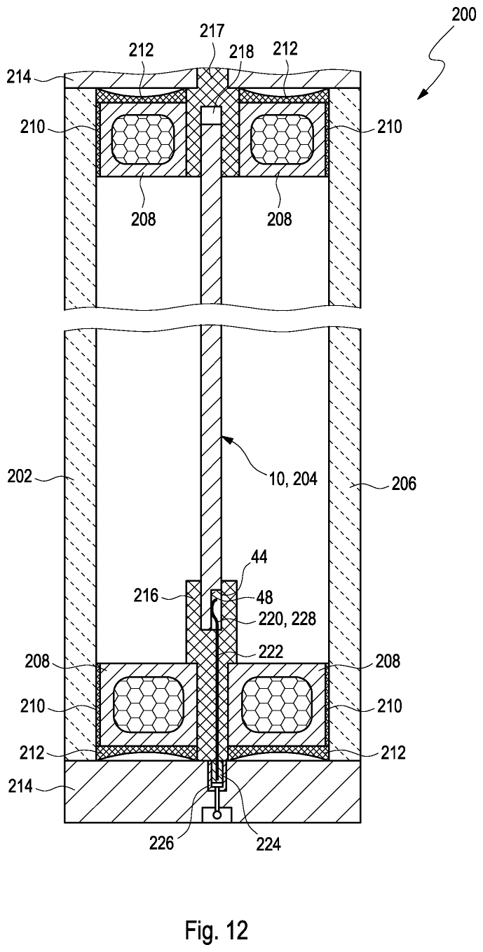

The second substrate 24, see FIG. 1, has two cut corners 44 which allow access to the first conductive layer 14. Beneath the cut corners 44, the conductive layer 14 comprises metallized surfaces 48 which may, for example, be contacted by means of a spring contact 220, see FIG. 12. As can be seen in FIG. 2, both metallized surfaces 48 abut against a first edge 86 of the first substrate 12 of the switchable optical device 10.

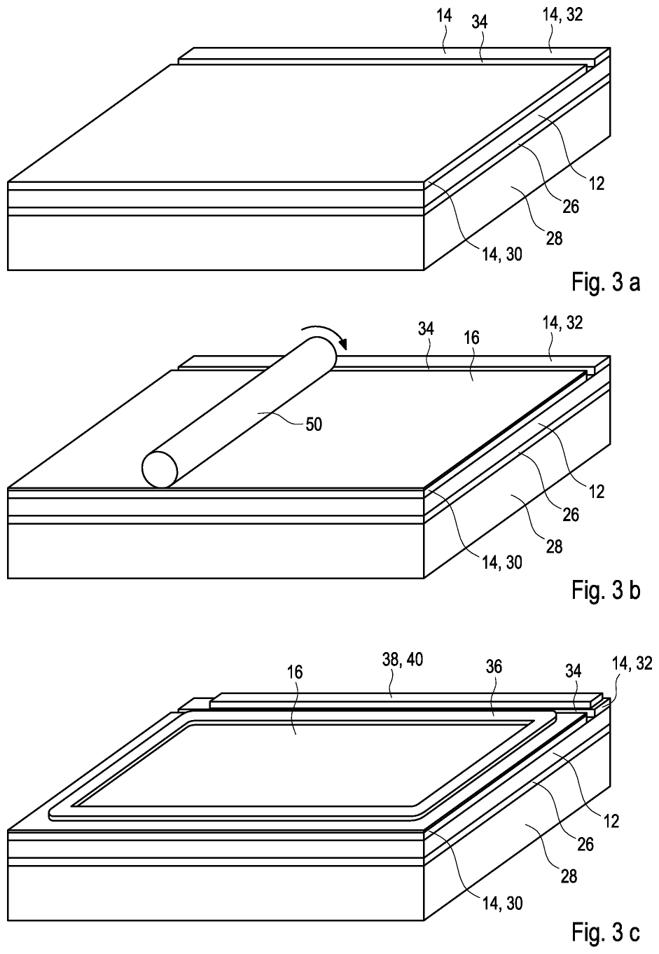

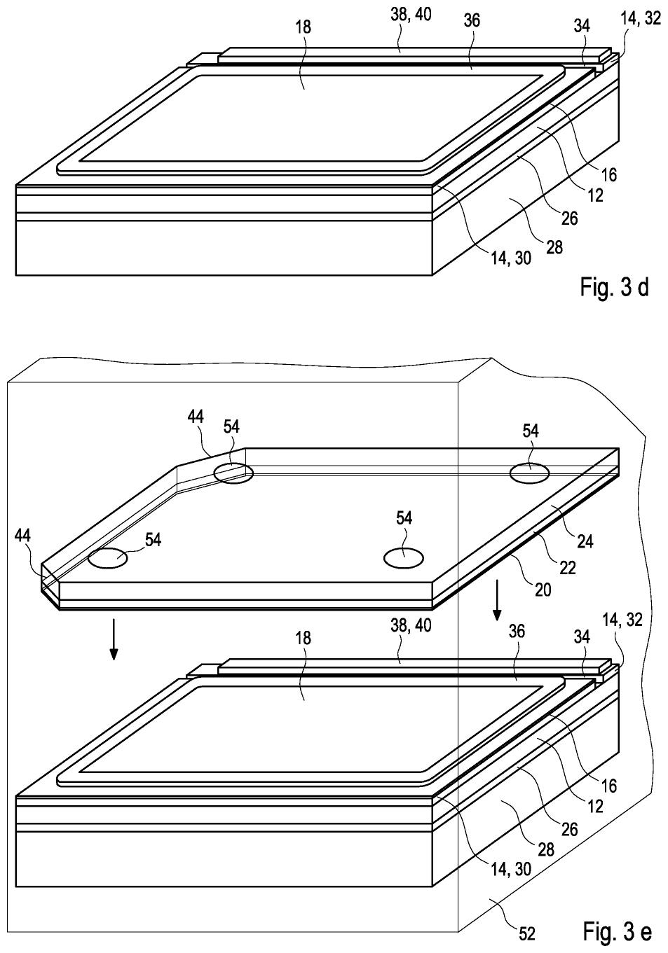

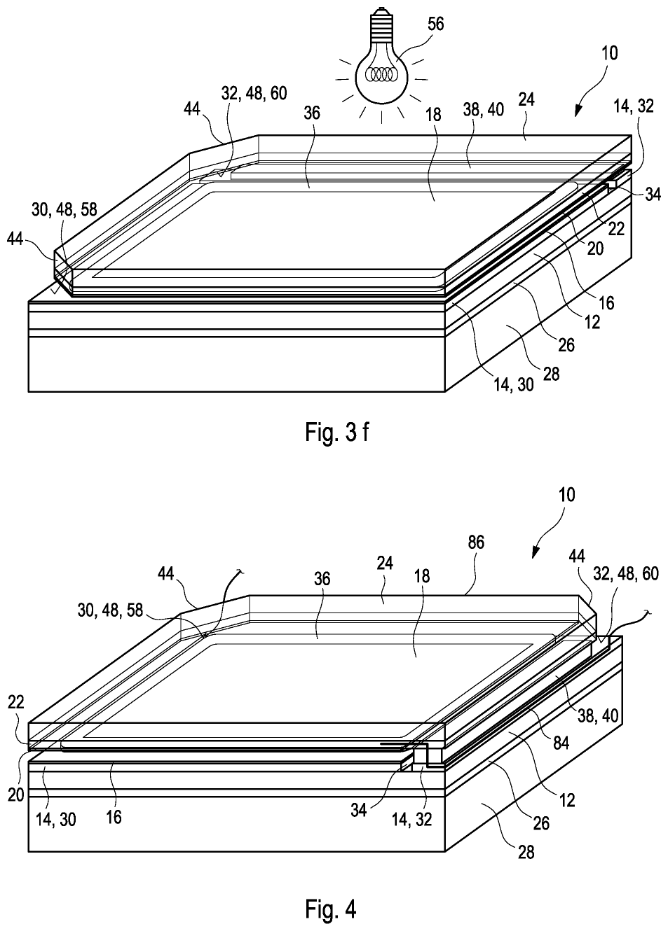

FIGS. 3a to 3f show a process for manufacturing of a switchable optical device 10.

In a first step a) shown in FIG. 3a, a first substrate 12 which is coated with the first conductive layer 14 is provided. The first conductive layer 14 may, for example, be a transparent ITO layer. The first conductive layer 14 is structured, for example by means of laser process or a photolithographic process, to form the insulated zone 34.

Further, in the example depicted in FIG. 3a, the first substrate 12 is laminated to a further sheet 28 by means of an interlayer 26.

In a second step b) shown in FIG. 3b, first alignment layer 16 for liquid crystals is applied. The first alignment layer 16 is, for example, a polyimide layer. The first alignment layer 16 is structured by rubbing using a roller 50.

In a third step c) shown in FIG. 3c, a glue line 36 for forming a seal for liquid crystalline medium is applied. Also, an electrical interconnect 38 is prepared by applying an adhesive comprising metal spacers 40, see FIG. 1. Optionally, the first alignment layer 16 is partially removed before applying the glue line 36 and/or before preparing the electrical interconnect 38.

In a forth step d) shown in FIG. 3d, the liquid crystalline medium is provided. In the example of FIG. 3d, the liquid crystalline medium is provided by means of one drop filling. Alternatively, other filing techniques such as, for example, ink jet printing or a vacuum filing process may be used. The liquid crystalline medium may comprise spacers to ensure a uniform thickness of the switchable layer 18.

A fifth step e) shown in FIG. 3e, is performed in vacuum. Air is evacuated, for example in a vacuum assembly-unit having a vacuum chamber 52 and a second substrate 24 having two cut corners 44 is provided. For handling of the second substrate 24 chucks 54 are used. The chucks 54 may, for example, be electrostatic chucks or gecko chucks. The second substrate 24 is placed onto the prepared glue line 36 by means of the chucks 54 so that the second substrate 24 is aligned to the first substrate 12.

In a last step f) shown in FIG. 3f the adhesives used in the glue line 36 and the electrical interconnect 38 are cured by means of UV-radiation. The UV-radiation is applied by means of UV-source 56. Optionally, a further heat-curing step may be applied.

Due to the cut corners 44 of the second substrate 24, access is provided to a first electrical contact 58 in the first contact zone 30 and to a second electrical contact 60 in the second contact zone 32. By applying a driving signal to the first and second electrical contacts 58, 60, the state of the switchable optical device 10 may be controlled. The first and second electrical contacts 58, 60 abut against the first edge 86 of the first substrate 12 of the switchable optical device 10.

FIG. 4 shows the switchable optical device 10 of FIGS. 1 and 2 in perspective view.

As already described with respect to FIG. 1, the switchable optical device 10 comprises in this order the further sheet 28, the interlayer 26, the first substrate 12, the first conductive layer 14, the first alignment layer 16, the switchable layer 18, the second alignment layer 20, the second conductive layer 22 and the second substrate 24. The switchable layer 18 is enclosed by a seal formed by the glue line 36 so that the switchable layer 18 is not visible in the perspective view of FIG. 4.

As shown in FIG. 4, a driving signal, such as an alternating sine wave signal, a square wave or a DC signal, may be applied to the first electrical contact 58 located in the first contact zone 30 and to the second electrical contact 60 located in the second contact zone 32. The first contact zone 30 of the first conductive layer 14 is in direct contact to the electrode zone 29, see FIGS. 1 and 2. For suppling the driving signal to the second conductive layer 22, the electrical interconnect 38 is used. The electrical interconnect 38 connects the second contact zone 32 to the second conductive layer 22 so that the driving signal may reach the second conductive layer 22 along the electric path 84.

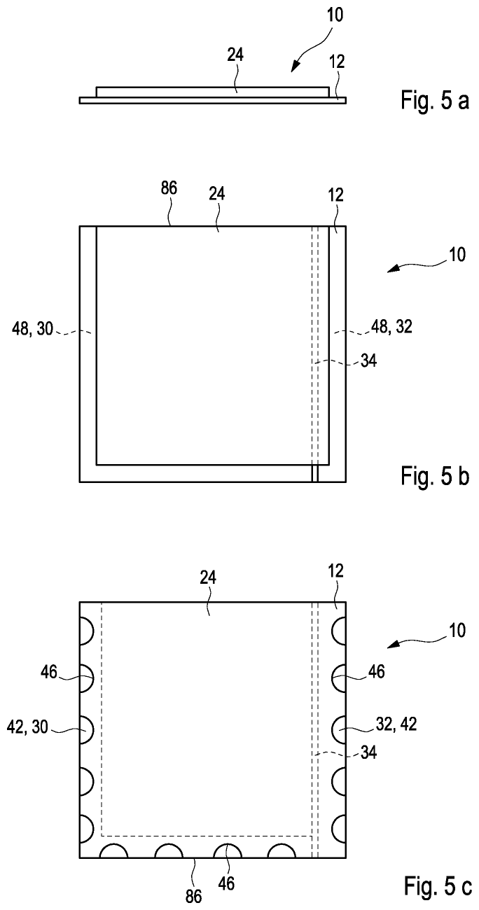

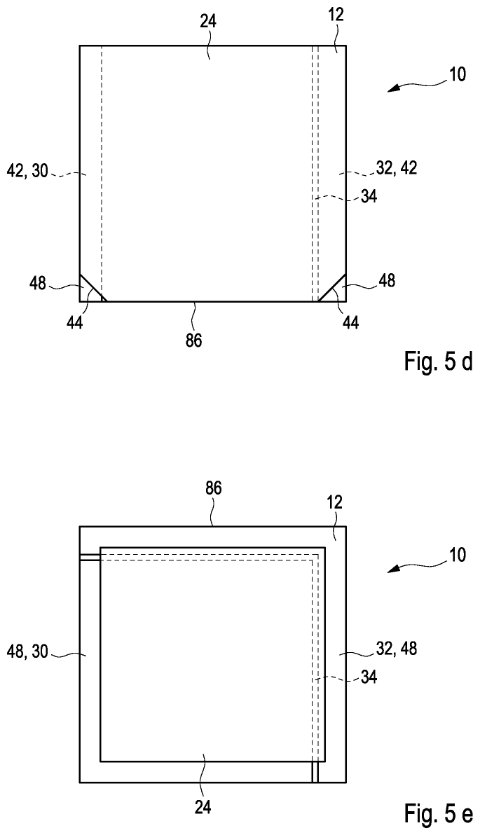

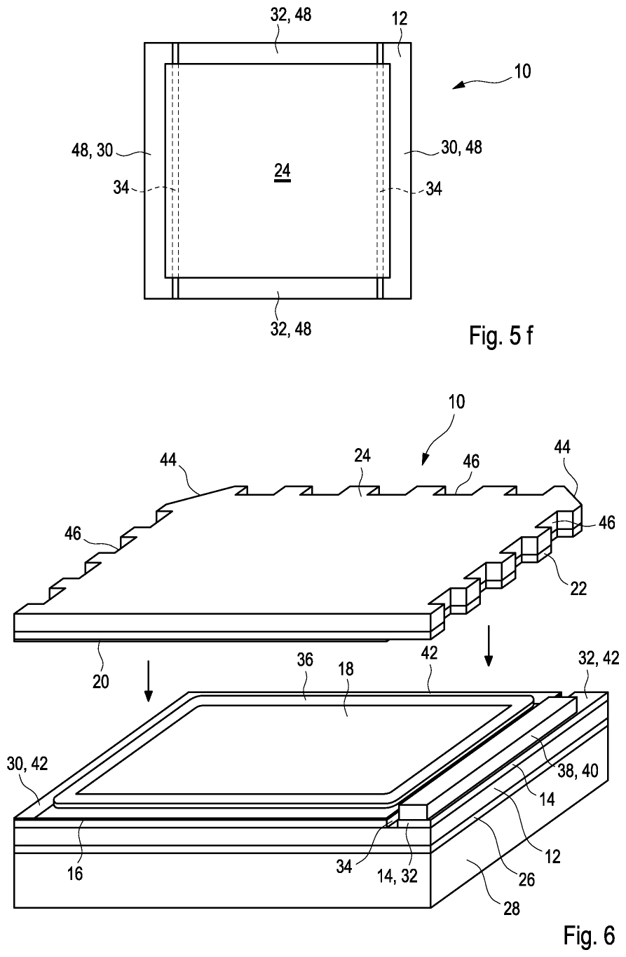

FIGS. 5a to 5d show alternative embodiments of the switchable optical device 10 in a simplified schematic view in which most of the layers and the electrical interconnect 38 have been omitted.

In the second embodiment of FIGS. 5a and 5b, the second substrate 24 is of a smaller size than the first substrate 12. FIG. 5a shows a side view and FIG. 5b shows a top view of the switchable optical device 10. As can be seen in the top view of FIG. 5b, the second substrate 24 is aligned to the first edge 86 of the first substrate 12 and is otherwise centered above the first substrate 12. In this arrangement, parts of the first conductive layer 14 remain uncovered so that the first contact zone 30 and the second contact zone 32 are accessible and may be contacted, for example, by means of a spring contact 220, see FIG. 12. In order to improve the electrical conductivity, a metal conductor 48 may be provided in the first contact zone 30 and the second contact zone 32, for example by means of sputtering of a metal film or by applying a conductive metal foil or a bus bar.

FIG. 5c shows a third embodiment of the switchable optical device 10 in a top view. Both the first substrate 12 as well as the second substrate 24 have essentially the same size and shape but the second substrate 24 is provided with multiple cut-outs 46 which allow access to the first contact zone 30 and the second contact zone 32, respectively. The second substrate 24 is aligned to the edges of the first substrate 12. As already shown in the second embodiment of FIGS. 5a and 5b, the first and second contact zone 30, 32 may be provided with a metal conductor 48 for improving the conductivity. The cut-outs 46 assigned to the second contact zone 30 extend along another edge which is adjacent to the first edge 86. In the example sown in FIG. 5c, the cut-outs 46 have the shape of a semi-circle.

FIG. 5d shows a fourth embodiment of the switchable optical device 10 which is similar to the first embodiment of FIGS. 1 and 2. Both the first substrate 12 as well as the second substrate 24 have essentially the same shape and size. The second substrate 24 differs from the first substrate 12 in having two cut corners 44 which allow access to metallized surfaces 48 in the first contact zone 30 and second contact zone 32, respectively. The first and second contact zones 30, 32 each abut against the first edge 86 of the first substrate 12. The first contact zone 30 extends along the entire length of an edge adjacent to the first edge 86 and the second contact zone 32 extends along the entire length of another edge adjacent to the first edge 86.

The first and second contact zones 30, 32 each comprise metal conductors 42 in the form of a sputtered metal film. In the embodiment shown in FIG. 5d, the material of the metallized surface 44 is identical to the sputtered film of the metal conductors 42.

FIG. 5e shows a fifth embodiment of the switchable optical device 10 which is similar to the second embodiment described with respect to FIGS. 4a and 5b. Similar to the second embodiment of the switchable optical device 10, the second substrate 24 of the switchable optical device 10 of the fifth embodiment is of a smaller size than the first substrate 12. Figure Se shows a top view of the switchable optical device 10. In contrast to the second embodiment shown in FIG. 5b, the second substrate 24 is smaller but of the same shape than the first substrate 12 and is centered above the first substrate 12. In this arrangement, parts of the first substrate 12 along all four of the edges remain uncovered so that the first contact zone 30 and the second contact zone 32 are accessible and may be contacted, for example, by means of a spring contact 220, see FIG. 12. Each of the first contact zone 30 and the second contact zone 32 extend along two adjacent edges. Accordingly, the insulated zone 34 has an angled shape having a first part aligned parallel to the first edge 86 and a second part being aligned parallel to an adjacent second edge. In this configuration, all four edges may be used for electrical contacting of the switchable optical device 10, wherein two adjacent edges are assigned to the same contact zone 30, 32, respectively, of the switchable optical device 10.

In order to improve the electrical conductivity, a metal conductor 48 may be provided in the first contact zone 30 and the second contact zone 32, for example by means of sputtering of a metal film or by applying a conductive metal foil.

FIG. 5f shows a sixth embodiment of the switchable optical device 10 which is similar to the fifth embodiment described with respect to FIG. 5e. As described with respect to the fifth embodiment of the switchable optical device 10, the second substrate 24 of the switchable optical device 10 of the sixth embodiment is of a smaller size than the first substrate 12 but has the same shape and is centered above the first substrate 12. In this arrangement, parts of the first substrate 12 along all four of the edges remain uncovered so that the first contact zone 30 and the second contact zone 32 are accessible and may be contacted. In contrast to the fifth embodiment, each of the first contact zone 30 and of the second contact zone 32 are divided into two sub-zones as two insulated zones 34 are used. The respective first and second sub-zones are located along opposing edges, respectively. In this configuration, all four edges may be used for electrical contacting of the switchable optical device 10, wherein opposing edges are assigned to the same contact zone 30, 32 of the switchable optical device 10.

In order to improve the electrical conductivity, a metal conductor 48 may be provided in the first contact zone 30 and the second contact zone 32, for example by means of sputtering of a metal film or by applying a conductive metal foil.

The features of the different embodiments of the switchable optical device 10 may be combined. For example, the arrangement of the first contact zone 30 and of the second contact zone 32 as shown in the fifth and sixth embodiments of FIGS. 5e and 5f, respectively, may be combined with second substrates 24 having the same size and shape as the first substrate 12 and having cut-outs 46. The cut-outs may, for example, be shaped as shown in FIG. 5c.

FIG. 6 shows a fifths embodiment of a switchable optical device 10 having multiple cut-outs 46 in an exploded perspective view. The switchable optical device 10 of the fifths embodiment is identical to the third embodiment of FIG. 5c except for the shape of the cut-outs 46. In the fifth embodiment, the cut-outs 46 have a rectangular shape.

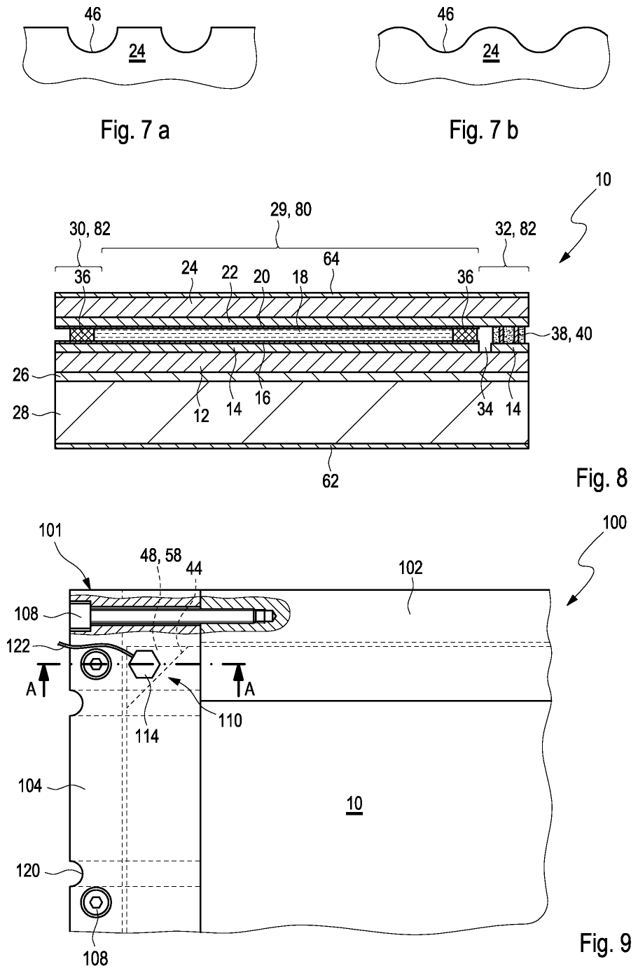

In FIGS. 7a and 7b alternative shapes for the cut-outs 46 are shown. In FIG. 7a, the cut-outs 46 have a shape of a rounded rectangle. In FIG. 7b, a sine-wave pattern for the cut-outs 46 is shown.

The cut-outs 46 may be produced by means of laser cutting of the second substrate 24.

FIG. 8 shows a schematic side view of an embodiment of the switchable optical device 10 which includes film heaters 62, 64.

The switchable optical device 10 of FIG. 8 has essentially the same structure as the switchable optical device of FIG. 1. The switchable optical device 10 has a layer structure which comprises in this order a first film heater 62, the further sheet 28, the interlayer 26, the first substrate 12, the first conductive layer 14, the switchable layer 18 surrounded by the glue line 36, the second conductive layer 22, the second substrate 24 and a second film heater 64. Further, the switchable optical device 10 includes the electrical interconnect 38 for contacting the second conductive layer 22.

The film heaters 62, 64 are preferably constructed as transparent conductive film, for example an ITO or FTO film. When an electric current is applied to the film heater 62, 64, the film heater 62, 64 warms up due to the electrical resistance of the transparent conductive film.

In FIG. 9 a section of a window element 100 is shown in top view.

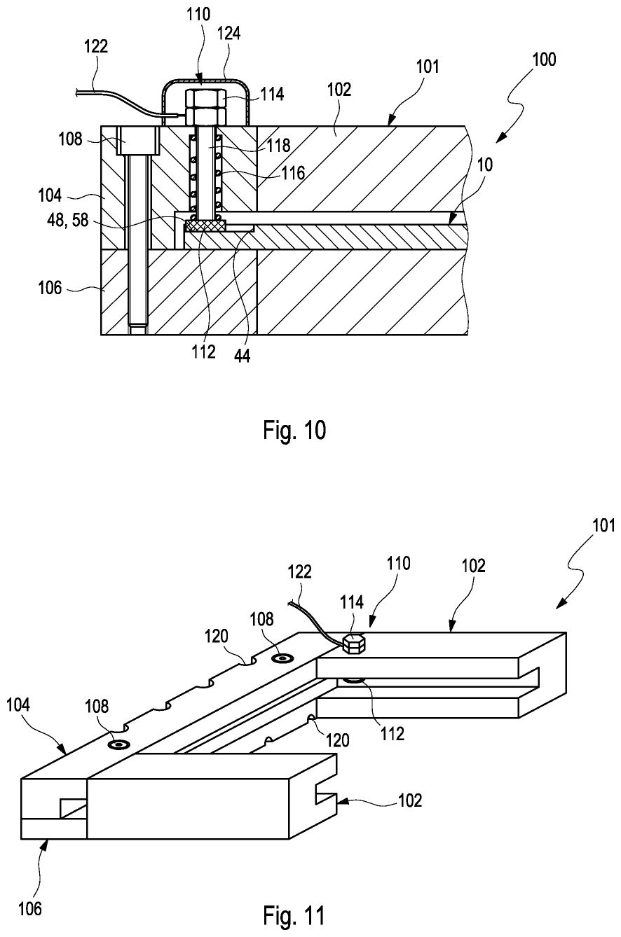

The window element 100 comprises a switchable optical device 10 and a frame 101. The frame 101 comprises profile parts 102, 104, 106 (see FIGS. 10 and 11) which are connected to each other by means of connecting elements such as screws 108. The switchable optical device 10 is received in the frame 101.

The frame 101 additionally comprises electrical spring contacts 110 for electrically contacting metallized surfaces 48 of the switchable optical device 10. In the section shown in FIG. 9, only the first electrical contact 58 with its metallized surface 48 is visible. The metallized surface 48 is accessible through the cut corner 44.

FIG. 10 shows a cross section view of the window element 100 of FIG. 9 along the line marked with A-A. The window element 100 comprises the frame 101 and the switchable optical device 10. The frame 101 comprises profile parts 102, 104, 106 and receives the switchable optical device 10. The profile parts 102, 104, 106 are connected to each other by means of screws 108.

The frame 101 comprises the electrical spring contact 110 for contacting the metallized surface 48. The electrical spring contact 110 comprises a shaft 118 and a conductive rubber surface 112 which is in contact with the metallized surface 48 of the switchable optical device 10. A spring 116, which abuts a shoulder of the profile part 102 tensions the rubber surface 112 of the electrical spring contact 110 against the metallized surface 44 of the switchable optical device 10 to ensure a reliable electrical connection while at the same time avoiding mechanical stress. The cable 122 is secured to the shaft 118 by means of nuts 114.

A cable 122 is connected to the electrical spring contact 110 in order to supply a driving signal to the switchable optical device 10. The electrical spring contact 110 is protected by means of a cover 124.

FIG. 11 shows a section of the frame 101 of the window element 100 in a perspective view. As can be seen in FIG. 11, the frame 101 of the window element 100 consists of three types of profile parts 102, 104, 106. A first profile part 102 is essentially “U”-shaped and forms the sides of the frame 101. The top and bottom sides of the frame 101 are each formed by a second profile part 104, which is essentially “L”-“shaped and a third profile part 106 which is essentially of rectangular shape.

A second profile part 104 and a third profile part 106 are joined and form a profile having essentially a “U”-shape. For assembling of the frame 101 around a switchable optical device 10, the two first profile parts 102 are provided and cut to the size of the switchable optical device. Further, two second profile parts 104 and two third profile parts 106 are provided and cut to the size of the switchable optical device 10. The two first profile parts 102 are arranged on opposing sides of the switchable optical device 10 such that the switchable optical device 10 engages in the recess of the U-shape. Then second profile parts 104 are respectively connected to third profile parts 106 by means of screws 108. As last step, the second parts 104 are connected to the first profile parts 102.

Preferably, the size of the frame 101 is chosen such that the switchable optical device 10 has space to expand in order to avoid mechanical stress due to thermal expansion.

The frame 101 may further comprise air channels 120 which allow the passage of air when the frame 101 is mounted in a window.

FIG. 12 shows a first embodiment of a switchable glazing unit 200.

The switchable glazing unit 200 of FIG. 12 is configured as an insulated glazing unit having a first pane 202, a second pane 206 and a middle pane 204. A gap is arranged between the first pane 202 and the middle pane 204 and between the middle pane 204 and the second pane 206, respectively. Spacers 208 are inserted between the first pane 202 and the middle pane 204 and between the middle pane 204 and the second pane 206, respectively.

The first pane 202 and the second pane 206 are configured as glass panes. An example for the material of the glass panes is soda-lime glass, including tempered or heat-strengthened versions thereof, which may be produced in a float glass process.

The spacers 208 are attached to the panes 202, 204, 206 by means of a first seal 210 which is, for example, a butyl seal. The outward facing sides of the spacers 208 are sealed by means of a second seal 212 which is, for example, a polysulfone seal. The spacers 208 may comprise a desiccant.

The middle pane 204 is configured as a switchable optical device 10 which is received by a first holder 216 at the bottom and by a second holder 217 at the top. Both the first holder 216 and the second holder 217 have a recess for receiving the switchable optical device 10. Further holders may be arranged at the sides of the switchable optical device 10. At the second holder 217, a space 218 is arranged in order to accommodate for thermal expansion of the switchable optical device 10.

The switchable optical device 10 comprises the first substrate 12, the second substrate 24 and the functional layers forming the switchable element as described with respect to FIG. 1. The switchable optical device 10 of the embodiment of FIG. 12 does not comprise a further sheet 28.

In the embodiment shown in FIG. 12, the second holder 217 is configured to be flush with the spacers 208. In such a configuration, non-switchable areas 82 of the switchable optical device 10, see FIG. 1, may be hidden. The first holder 216 of the embodiment shown in FIG. 12 extends beyond the spacers 208. In such a configuration, the first holder 216 may compensate for a smaller size of the switchable optical device 10 compared to the first pane 202 and second pane 206. If the size of the switchable optical device 10 is sufficiently large, both the first holder 216 as well as the second holder 217 may be configured to be flush with the spacers 208.

The first holder 216 arranged at the bottom of the switchable optical device 10 comprises a spring contact 220 which in the embodiment of FIG. 12 is configured as a bending spring 228. The spring contact 220 engages the metallized surface 48 of the switchable optical device 10. In the cross section view of FIG. 12, only a single spring contact 220 is visible, but the first holder 216 comprises two spring contacts 220 in order to contact the first electrical contact 58 as well as the second electrical contact 60 of the switchable optical device 10, see FIG. 4. In order to have good corrosion resistance it is preferred to use plated noble metal contacts for spring contact 220. Preferably, gold is used as noble metal.

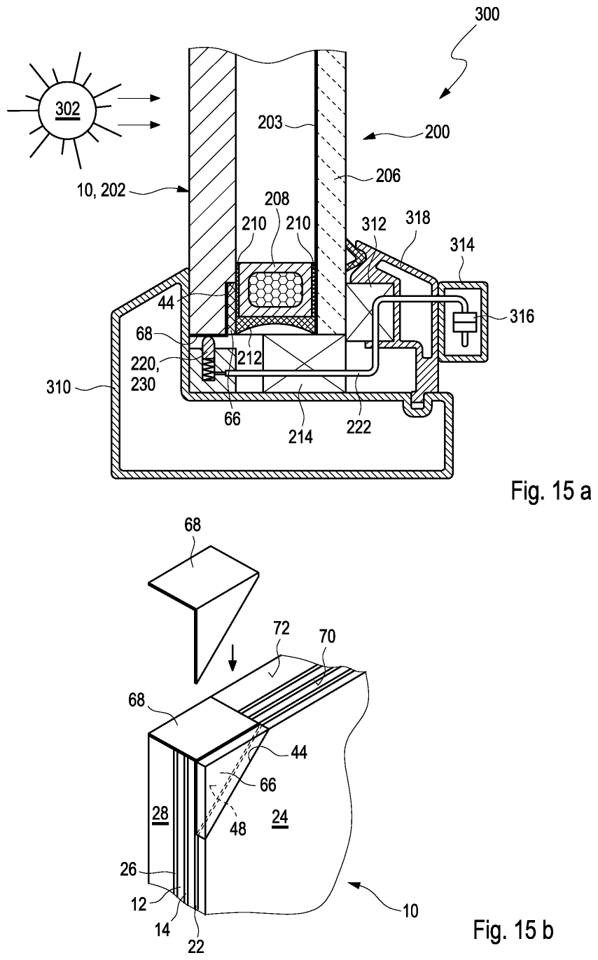

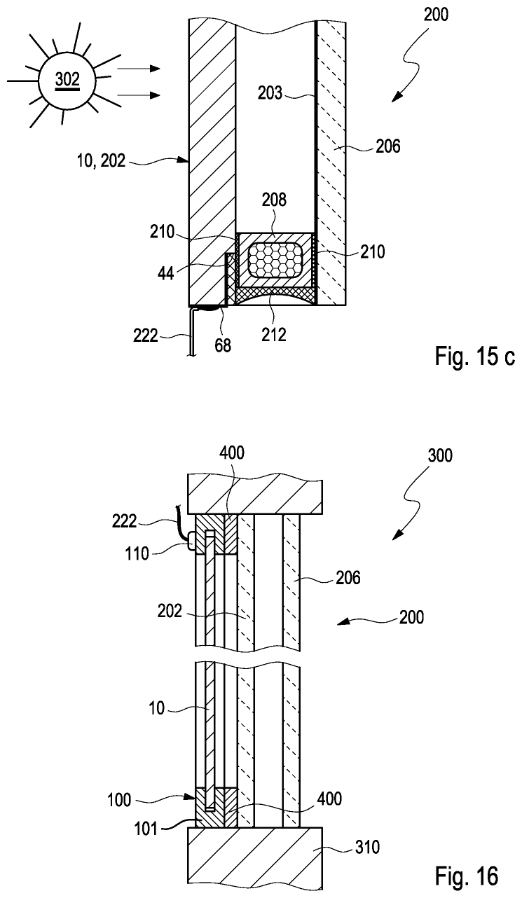

For installation of the switchable glazing unit 200 in a window frame 310 (see FIG. 15a), a support block 214 is provided. The support block 214 comprises an electrical socket 226 for receiving of an electrical connector 224 of the switchable glazing unit 200. The electrical connector 224 is connected to the spring contact 200.

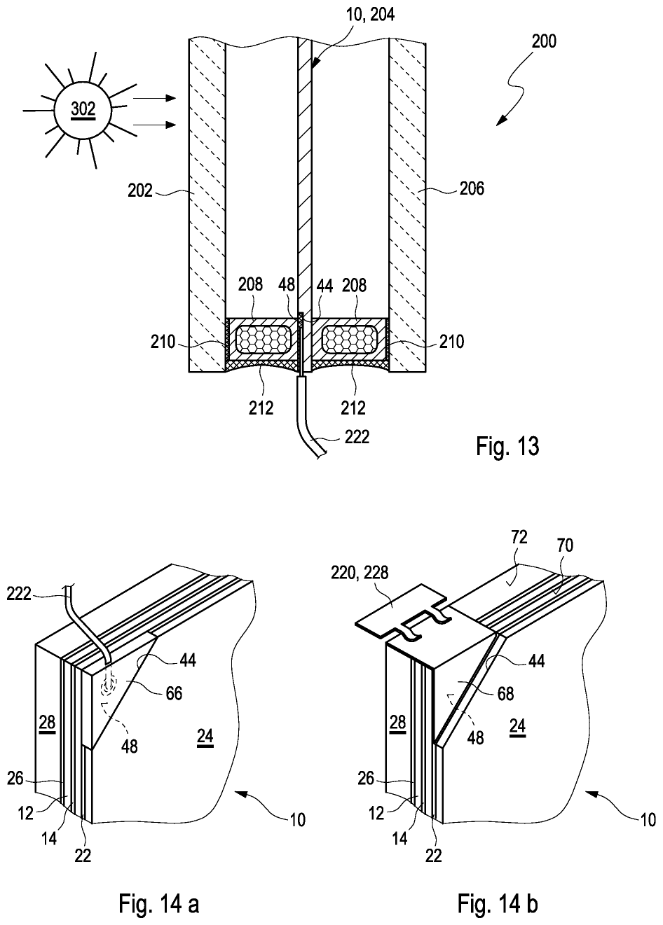

FIG. 13 shows a second embodiment of the switchable glazing unit 200.

The switchable glazing unit 200 of FIG. 13 is configured as an insulated glazing unit having a first pane 202, a second pane 206 and a middle pane 204. A gap is arranged between the first pane 202 and the middle pane 204 and between the middle pane 204 and the second pane 206, respectively. Spacers 208 are inserted between the first pane 202 and the middle pane 204 and between the middle pane 204 and the second pane 206, respectively.

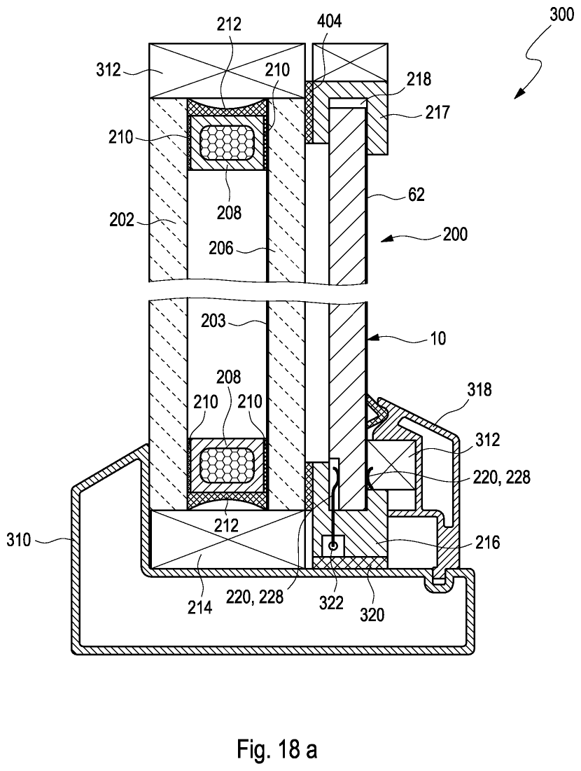

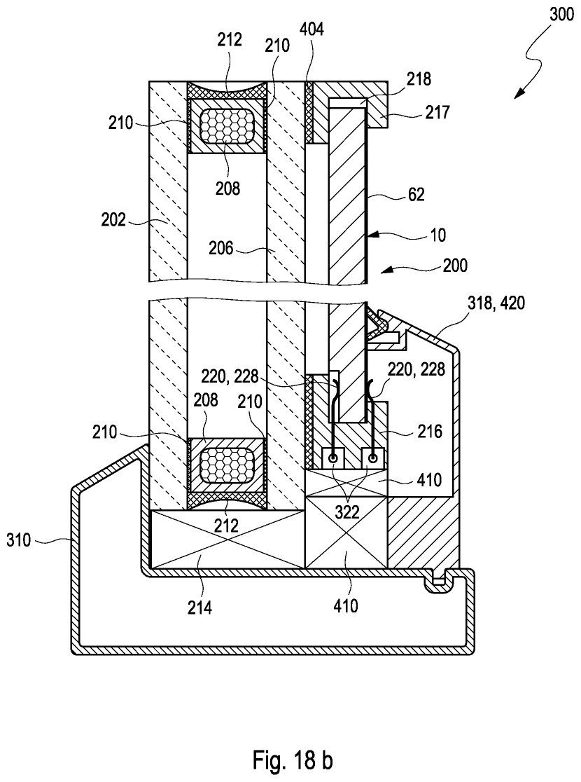

The first pane 202 and the second pane 206 are configured as glass panes. An example for the material of the glass panes is soda-lime glass which may be produced in a float glass process. The first pane 202 is, when the switchable glazing unit 200 is used as a window, arranged to face outwards as indicted in FIG. 13 by sun 302. Optionally, a low-e coating 203 may be arranged on the surface of the first pane 202 which faces inwards towards the middle pane 204, see for example FIG. 18a.

The spacers 208 are attached to the panes 202, 204, 206 by means of a first seal 210 which is, for example, a butyl seal. The outward facing sides of the spacers 208 are sealed by means of a second seal 212 which is, for example, a polysulfone seal.

A switchable optical device 10 is used as middle pane 204. The switchable optical device 10 of the embodiment of FIG. 13 does not comprise a further sheet 28. An electrical connection to the first and second electrical contacts 58, 60 of the switchable optical device 10, see FIG. 4, are configured as cables 222 which are attached to the electrical contact 58, 60 of the switchable optical device 10, see FIG. 14a.

When installed in a window, it is preferred to use a support block having a channel for accommodating the cables 222.

FIG. 14a shows an enlarged perspective view of the first electrical contact 58 of the switchable window 10 used in the switchable glazing of FIG. 13. The first conductive layer 14 of the switchable optical device is accessible through a cut corner 44 of the second substrate 24. The cable 222 is directly attached to the first conductive layer 14 on the first substrate 12 by means of ultrasonic soldering. The connection of the cable 222 to the conductive layer 14 is covered by means of a potting material 66.

FIG. 14b shows an alternative embodiment of the electrical contacts of the switchable optical device 10 used in the switchable glazing 200 of FIG. 13.

The switchable optical device 10 comprises a further sheet 28 laminated to the first substrate 12. A metal contact sheet 68 is attached to the first conductive layer 14, see FIG. 1, and extends beyond the first substrate 12. The metal contact sheet 68 is bent around the edge of the first substrate 12 and covers a part of an edge surface 70 of the first substrate 12 and of an edge surface 72 of the further sheet 28.

The metal contact sheet 68 provides a contact surface which may be contacted by means of a spring contact 220. For example, a bending spring 228 may be used in a window frame 310 to contact the metal contact sheet 68, see FIG. 15a.

FIG. 15a shows a third embodiment of the switchable glazing unit 200.

The switchable glazing unit 200 of FIG. 15a is configured as an insulated glazing unit having a first pane 202 and a second pane 206. A gap is arranged between the first pane 202 and the second pane 206 and a spacer 208 is inserted between the first pane 202 and the second pane 206.

The second pane 206 is configured as a glass pane. An example for the material of the glass pane is soda-lime glass which may be produced in a float glass process. A switchable optical device 10 having a further sheet 28 as described with respect to FIG. 1 is used as first pane 202. The switchable device 10 is arranged such that, when the switchable glazing unit is used as a window of a building or a vehicle, the further sheet 28 faces outside as indicated by the sun 302. On the surface of the second pane 206 which faces inwards towards the switchable optical device 10, a low-e coating 203 is arranged.

The spacers 208 are attached to the panes 202, 206 by means of a first seal 210 which is, for example, a butyl seal. The outward facing sides of the spacers 208 are sealed by means of a second seal 212 which is, for example, a polysulfone seal.

For supplying a driving signal, the switchable optical device 10 comprises metal contact sheets 68 which are contacted by the spring contact 220. In the embodiment of FIG. 15a, the spring contact 220 is configured as a spring loaded pin 230. In order to have good corrosion resistance it is preferred to use plated noble metal contacts for the spring contact 220. Preferably, gold is used as noble metal.

In the embodiment of FIG. 15a, the switchable glazing unit 200 is part of a window 300 having window frame 310 which accommodates the switchable glazing unit 200. A support block 214 and a block 312 are provided to support and secure the switchable glazing unit 200 in the window frame 310. The window frame 310 may comprise a connection box 314 for housing electrical connectors 316. The electrical connectors 316 are connected to the spring contact 220 by means of a cable 222.

A controller may be used to generate driving signals for the switchable optical device. The controller may be connected to the electrical connectors 316.

FIG. 15b shows a detailed view of the switchable optical device 10 having a metal contact sheet 68 which is attached to the first conductive layer 14 on the first substrate 12. Potting material 66 may be applied to protect the connection of the metal contact sheet 68 to the first conductive layer 14. The metal contact sheet 68 is attached to the first conductive layer 14, see FIG. 1, and extends beyond the first substrate 12. The metal contact sheet 68 is bent around the edge of the first substrate and covers a part of an edge surface 70 of the first substrate 12 and of an edge surface 72 of the further sheet 68, see FIG. 14b.

FIG. 15c shows a variant of the third embodiment of the switchable glazing unit 200 as described with respect to FIG. 15a having alternative electrical contacts. In the variant of FIG. 15c, a cable 222 is directly connected to the switchable optical element 10.

FIG. 16 shows a forth embodiment of the switchable glazing unit 200 which is formed by retro-fitting of an existing window 300.

The window 300 comprises a window frame 310 and an insulated glazing unit having a first pane 202, and a second pane 206.

For retro-fitting of the window 300, a window element 100 and mounting elements 400 are provided. In a first step, the mounting elements 400 are attached to the first pane 202 of the insulated glazing unit of the existing window 300. The mounting elements 400 may, for example, be attached by means of an adhesive. In a second step, the switchable glazing unit 200 is formed by attaching the window element 100 to the mounting elements 400, for example by means of connecting elements such as screws or by means of an adhesive. The window element 100 as shown in FIG. 16 comprises the frame 101 and the switchable optical device 10 as shown in FIGS. 9 to 11.

In the example depicted in FIG. 16, the window element 100 is attached to the side of the window 300 which faces towards the outside of the building or vehicle.

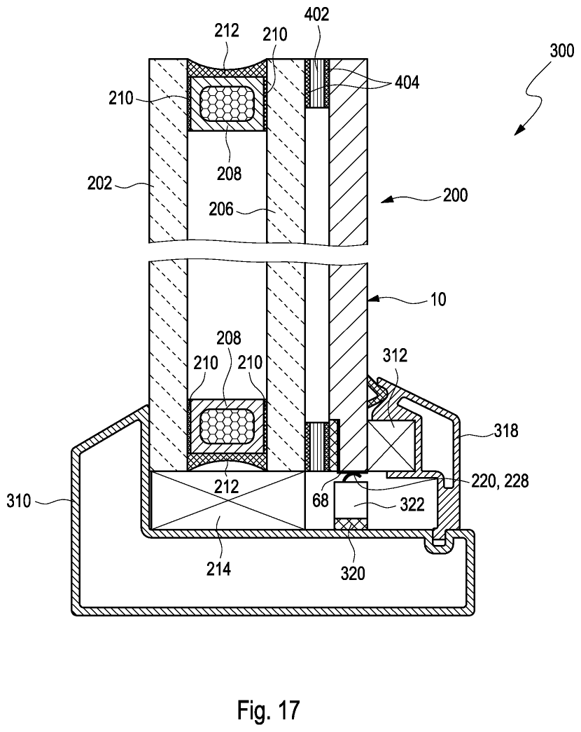

FIG. 17 shows a fifth embodiment of the switchable glazing unit 200 which may be formed by retro-fitting of an existing window 300.

The existing window 300 comprises a window frame 310 and an insulated glazing unit having a first pane 202, a second pane 206 and spacers 208. The insulated glazing unit is supported in the window frame 310 by means of a support block 214.

In the example shown in FIG. 17, a switchable optical device 10 is provided which is of the same size than the first and second panes 202, 206 of the existing window 300. The switchable optical device 10 is attached to the second pane 206 by means of mounting elements 402 having an air channel. The mounting elements 402 are attached to the second pane 206 by means of an adhesive 404. Also, the switchable optical device 10 is attached to the mounting elements 402 by means of an adhesive 404. The air channels of the mounting element 402 allow for venting of the air gap formed between the switchable optical device 10 and the second pane 206.

The switchable optical device 10 comprises metal contact sheets 68 for providing an electrical connection. In the example of FIG. 17, the contact sheets 68 are contacted by means of a spring contact 220 configured as a bending spring 228. The spring contact 220 is attached to an electrical connector 322. The electrical connector 322 is supported by a compensation element 320 which is preferably an elastic element.

A block 312 and a clamping bar 318 are provided to secure the switchable optical device 10 and to hide non-switchable areas 82 of the switchable optical device 10. The clamping bar 318 is attached to the window frame 310.

FIG. 18a shows a sixth embodiment of the switchable glazing unit 200 which may be formed by retro-fitting of an existing window 300.

The existing window 300 comprises a window frame 310 and an insulated glazing unit having a first pane 202, a second pane 206 and spacers 208. The insulated glazing unit is supported in the window frame 310 by means of a support block 214. On the surface of the second pane 206 which faces inwards towards the first pane 202, a low-e coating 203 is arranged.

In the example shown in FIG. 18a, a switchable optical device 10 is provided having the same size than the first and second panes 202, 206 of the existing window 300. The switchable optical device 10 is held by a first holder 216 at the bottom and is held by a second holder 217 at the top. The second holder 217 provides a space 218 to accommodate for thermal expansion of the switchable optical device 10. The first and second holders 216, 217 are attached to the second pane 206 by means of an adhesive 404. Further, the first holder 216 is supported by the window frame 310.

A clamping bar 318 is provided to secure the first holder 216 and to hide non-switchable areas 82 of the switchable optical device 10. The clamping bar 318 is attached to the window frame 310.

The switchable optical device 10 of FIG. 18a is provided with a film heater 62. The film heater 62 as well as the first and second electrical contacts 58, 60, see FIG. 4, are contacted by means of spring contacts 220 located in the first holder 216.

FIG. 18b shows the sixth embodiment of the switchable glazing 200 having a switchable optical device 10 of different size.

In the example shown in FIG. 18b, a switchable optical device 10 is provided which is of a smaller size than the first and second panes 202, 206 of the existing window 300. To compensate for the size difference, spacer blocks 410 are provided which support the switchable optical device 10. The first and second holders 216, 217 are attached to the second pane 206 by means of an adhesive 404. Further, the first holder 216 is supported by the spacer blocks 410.

In order to hide the size difference and in addition to hide non-switchable areas 82 of the switchable optical device 10, a passepartout-frame 420 is provided in form of an enlarged clamping bar 318. The clamping bar 318 is attached to the window frame 310.

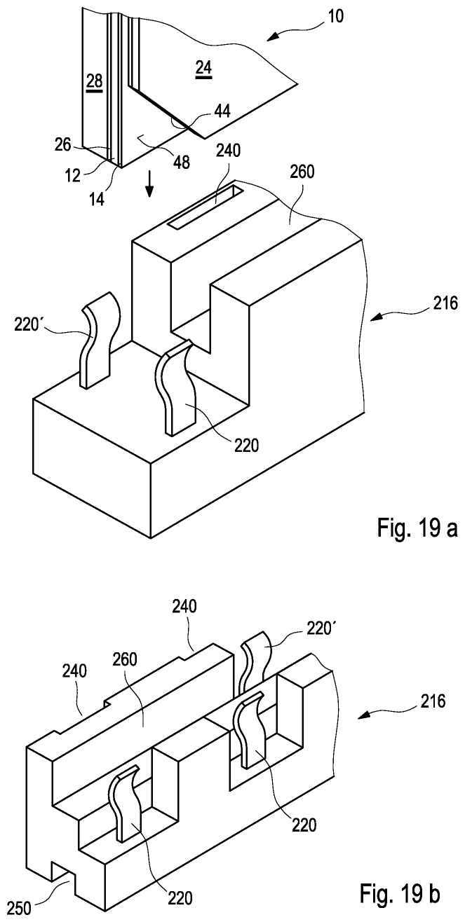

FIGS. 19a and 19b show two embodiments of first holders 216 with spring contacts 220.

In FIG. 19a, a section of a switchable optical device 10 is shown having a cut corner 44 which exposes the metallized surface 48. Further, the switchable optical device 10 has a film heater 62 on the opposing side.

The first holder 216 comprises a recess 260 for receiving the switchable optical device 10. Further, the first holder 216 comprises a spring contact 220 for engaging the metallized surface 48. A further spring contact 220′ is arranged to contact the film heater 62. Additionally, the first holder 216 as depicted in FIG. 19a comprises an air vent 240 which allows for the passage of air.

FIG. 19b shows an alternative embodiment of the first holder 216 which comprises a plurality of spring contacts 220 for engaging a metallized surface 48 which is exposed by multiple cut-outs 46 as depicted, in FIGS. 5c and 6.

A further spring contact 220′ is arranged to contact a film heater 62 of the switchable optical device. Additionally, the first holder 216 as depicted in FIG. 19b comprises multiple air vents 240 which allows for the passage of air and a channel 250 for accommodating cables.

### LIST OF REFERENCE NUMERALS

10 switchable optical device
12 first substrate
14 first conductive layer
16 first alignment layer
18 switchable layer
20 second alignment layer
22 second conductive layer
24 second substrate
26 interlayer
26′ interlayer with UV protection
28 further sheet
29 electrode zone
30 first contact zone
32 second contact zone
34 insulated zone
36 glue line
38 electrical interconnect
40 metal spacer
42 metallic conductor
44 cut corner
46 (multiple) cut-out
48 metallized surface
50 roller
52 vacuum chamber
54 handling chuck
56 UV-source
58 first electrical contact
60 second electrical contact
62 first film heater
64 second film heater
66 potting
68 metal contact sheet
70 edge surface of first substrate
72 edge surface of further sheet
80 switchable area
82 non-switchable area
84 electric path
86 first edge
100 window element
101 frame
102 first profile part
104 second profile part
106 third profile part
108 screw
110 electrical spring contact
112 conductive rubber
114 nut
116 spring
118 shaft
120 air channel
122 cable
124 cover
200 switchable glazing unit
202 first pane
203 low-e layer
204 middle pane
206 second pane
208 spacer
210 first seal
212 second seal
214 support block
216 first holding element
217 second holding element
218 space
220 electric spring contact
222 cable
224 connector
226 socket
228 bending spring
230 spring loaded pin
240 vent
250 channel
300 window
302 sun
310 window frame
312 block
314 connection box
316 electrical connector
318 clamping bar
320 compensation element
322 electrical connector
330 el. connector for heater
400 mounting element
402 mounting element with air channel
404 adhesive
410 spacer-block
420 passepartout frame

1. Switchable optical device (10) comprising in this order a first substrate (12), a first conductive layer (14), a switchable layer (18), a second conductive layer (22) and a second substrate (24), characterized in that
i) the first conductive layer (14) comprises a first contact zone (30) and a second contact zone (32), wherein the first contact zone (30) is electrically insulated from the second contact zone (32) and wherein the switchable optical device (10) comprises an electrical interconnect (38) for electrically connecting the second contact zone (32) of the first conductive layer (14) to the second conductive layer (22) and/or
ii) the switchable optical device (10) comprises at least one further sheet (28) which is laminated to the first substrate (12) and/or the second substrate (14), wherein first substrate (12), the second substrate (24) and the at least one further sheet (28), have essentially the same thermal expansion coefficient.

2. The switchable optical device (10) of claim 1, characterized in that the electrical interconnect (38) is selected from conductive adhesives, structured conductive films, metal spacers (40) and combinations thereof.

3. The switchable optical device (10) of claim 1, characterized in that the first contact zone (30) of the first substrate (14) extends along at least two edges of the first substrate (12) and/or the second contact zone (32) extends along the entire length of at least one edge of the first substrate (12).

4. The switchable optical device (10) of claim 1, characterized in that a metallic conductor (42) extends over the entire area of the first contact zone (30) and/or a metallic conductor (42) extends over the entire area of the second contact zone (32).

5. The switchable optical device (10) of claim 1, characterized in that the second substrate (24) is smaller than the first substrate (12) and is arranged centered above the first substrate (12) or in that the second substrate (24) comprises at least one cut corner (44) and/or multiple cut-outs (46) arranged on at least one edge of the second substrate (24).

6. The switchable optical device (10) of claim 1, characterized in that the switchable optical device (10) further comprises a first metal contact sheet (68) which contacts the first contact zone (30) and a second metal contact sheet (68) which contacts the second contact zone (32), wherein the first and second metal contact sheets (68) extend beyond the first substrate (12) and are bent such that they cover parts of an edge-surface (70) of the first substrate (12) and, if present, of an edge-surface (72) of the further sheet (28) laminated to the first substrate (12).

7. Switchable glazing unit (200) comprising at least one glass pane and at least one switchable optical device (10), characterized in that the at least one switchable optical device (10) is mechanically decoupled from the at least one glass pane and in that
a) the switchable glazing unit (200) comprises means for electrically contacting the at least one switchable optical device (10) which include at least one electrical spring contact (220, 110) and/or
b) the switchable glazing unit (200) is constructed as an insulated glazing unit comprising two or more panes (202, 204, 206) with gaps between the panes (202, 204, 206) and the at least one switchable optical device (10) is used as one of the panes (202, 204, 206) of the insulated glazing unit, and/or
c) the at least one switchable optical device (10) is a switchable optical device (10) according to claim 1.

8. The switchable glazing unit (200) of claim 7, characterized in that the switchable glazing unit (200) further comprises at least one window element (100) comprising the at least one switchable optical device (10), a frame (101) for mechanical decoupling and electrical contacting of the at least one switchable optical device (10) and at least one electrical spring contact (110) for contacting the at least one switchable optical device (10).

9. The switchable glazing unit (200) of claim 8, characterized in that the frame (101) is made from three types of frame profile parts (102, 104, 106), wherein the sides of the frame (101) are formed respectively by a first profile part (102) having a U-shaped profile and the top and bottom sides of the frame (101) are formed respectively by a second profile part (104) having a L-shaped profile and a third profile part (106) having a rectangular profile.

10. The switchable glazing unit (200) of claim 8, characterized in that the switchable glazing unit (200) further comprises electrical spring contacts (220) for electrically contacting the at least one switchable window element (100) and/or in that, that the switchable window element (100) further comprises an electrical cable, an electrical socket or an electrical contact surface for electrically contacting of the switchable window element (100).

11. The switchable glazing unit (200) of claim 7, characterized in that the electrical spring contact (220, 110) for contacting the at least one switchable optical device (10) according to aspect a) and/or for contacting the at least one switchable window element (100), if present, is configured as a bending spring (228) or a spring loaded contact pin (230).

12. The switchable glazing unit (200) of claim 7, characterized in that the switchable glazing unit (200) further comprises an insulated glazing unit having two or more panes (202, 204, 206) with gaps between the panes (202, 204, 206) and the at least one switchable optical device (10) is arranged adjacent to one of the panes (202, 204, 206).

13. The switchable glazing unit (200) of claim 7, characterized in that a switchable area (80) of the at least one switchable optical device (10) is smaller than an optically clear area of the at least one glass pane and that the switchable glazing unit (200) additionally comprises a passepartout-frame (420) for covering spacer-blocks (410) and/or non-switching areas (82) of the at least one switchable optical device (10).

14. The switchable glazing unit (200) of claim 7, characterized in that at least one glass pane and/or at least one switchable optical device (10) comprises a transparent electrical heater film (62, 64).

15. The switchable glazing unit (200) of claim 7, characterized in that the at least one switchable optical device (10) is selected from liquid crystal based devices, electrochromic devices, gasochromic devices, thermochromic devices, thermally switchable devices, suspended particle devices or combinations of at least two of these switchable optical devices.
